(19) United States
(12) Patent Application Publication
(10) Pub. No.: US 2013/0293780 A1
(43) Pub. Date: Nov. 7, 2013

(54) DISPLAY DEVICE AND METHOD FOR PRESENTING INFORMATION ON ENTITIES DISPLAYED ON VIDEO CONTENT

(71) Applicant: SAMSUNG ELECTRONICS CO., LTD., Suwon-si (KR)

(72) Inventors: Muthukumar SUBRAMANIAN, Tamil Nadu (IN); Ravi Kant BANSAL, Rajasthan (IN); Ajit JAIN, Delhi (IN); Devendra KHANDELWAL, Rajasthan (IN); Gunjan AGRAWAL, Haridwar (IN); Neeraj SOLANKI, Ghaziabad (IN); Pankaj THAKUR, Pune (IN)

(73) Assignee: SAMSUNG ELECTRONICS CO., LTD., Suwon-si (KR)

(21) Appl. No.: 13/888,669

(22) Filed: May 7, 2013

(30) Foreign Application Priority Data
May 7, 2012 (IN) 1755/CHE/2012
Apr. 5, 2013 (KR) 10-2013-0037700

(51) Int. Cl. H04N 5/46

(52) U.S. Cl. CPC H04N 5/46
USPC 348/554

(57) ABSTRACT

A display device and a method for providing information thereof are provided. The display device includes a display which displays a video content, a communication device which communicates with an external device, an input which receives a user command, and a controller which, when a predetermined command is input through the input, detects a plurality of entities included in the video content, and when at least one of the plurality of entities is selected through the input, controls the display to collect and display information regarding the selected at least one entity through the communication device.

### CROSS-REFERENCE TO RELATED APPLICATIONS

This application claims priority from Indian Patent Application 1755/CHE/2012, filed in the Indian Patent Office on May 7, 2012 and Korean Patent Application No. 10-2013-0037700, filed in the Korean Intellectual Property Office on Apr. 5, 2013, the disclosures of which are incorporated herein by reference.

### BACKGROUND

1. Field

Methods and apparatuses consistent with the exemplary embodiments relate to a display device, and a method for presenting information thereof, and more particularly, to a display device which detects one or more entities which are in a video content, or which are displayed on the display device and presents information regarding the detected entities and an information displaying method thereof.

2. Description of the Related Art

Recently, digital televisions have become increasingly popular. In one example, digital televisions are used for, but not limited to, watching a video content by a user. Examples of the video content include, but are not limited to, a live video, a streaming video and a stored video. Presenting information about one or more entities while watching, for example, the video content enables a user to gain knowledge of the entities. Information in one example may include the name of the entity, a location associated with the entity, a brief description of the entity or a detailed description of the entity. Examples of the entities include, but are not limited to, individuals, monuments, objects, products, living beings, for example, animals, birds and trees. However, a system for presenting information such that the user can gain knowledge of the entities is not available. Consequently, the user obtains the information associated with the entities at a later time by using one or more information sources, for example, books, the Internet and the like.

Related art techniques aim at detecting the faces of one or more individuals. Each individual is associated with a profile. The profile includes information content of the individual in the form of text. When the face of an individual is detected, a profile associated with the individual whose face was detected is retrieved. Upon retrieving the profile, the information included in the profile is presented to a user on a display device. The information is presented in a video form, textual form, affective or graphic information, or a combination of the video form, the audio form, the textual form. However, this technique merely provides the information that is stored prior to being presented on the display device. Consequently information associated with a live event that is being broadcasted is not known. Further, this technique is restricted to detecting and presenting only information associated with individuals, and does not present information associated with other entities, for example, monuments, locations, products, objects, birds, trees and the like.

In another example, a method and a system performs facial detection of multiple individuals included in a live video conference. This method includes detecting faces of individuals included in the live video conference. Further, faces detected are compared with multiple faces stored in a storage device to determine a match. Also, a voice of a person can also be detected along with the face for identifying an individual. Upon determining the individual, annotation is performed. The annotation includes personal information of the individual determined. The personal information of the individual is displayed in the form of a streaming video. A storage device is used for storing annotated information associated with each individual detected. However, the system is limited to capturing only faces of individuals included in the live video stream. Further, the system is restrained from detecting and annotating entities, for example, monuments, locations, products, objects, birds, trees and the like.

In the light of the foregoing discussion there is a need for a system and a method for detecting one or more entities present in a video content, for example, a live video, a streaming video and a stored video and an image that is displayed on a display device, and subsequently presenting information associated with the entities to the user.

### SUMMARY

An aspect of the exemplary embodiments relates to a display device which detects entities regarding a video content displayed on the display device and presents information regarding the detected entities and a system thereof.

A display device according to an exemplary embodiment includes a display configured to display a video content, a communication device configured to communicate with an external device, an input configured to receive a user command, and a controller configured to, when a predetermined command is input through the input, detect a plurality of entities included in the video content, and when at least one of the plurality of entities is selected through the input, control the display to collect and display information regarding the selected at least one entity through the communication device.

The controller may obtain a plurality of tag information regarding each of the plurality of entities, and the display may display each of the plurality of tag information adjacent to each entity.

The controller, when at least one of the displayed plurality of tag information is selected through the input, may collect information regarding an entity corresponding to the selected at least one tag information through the communication device.

The controller may collect and aggregate information regarding the selected at least one entity from a plurality of information sources, and the display may display the aggregated information.

The information regarding the selected at least one entity may be information in at least one of text form, audio form and image form.

The controller may provide information regarding the selected at least one entity in one of a plurality of presentation modes.

The plurality of presentation modes may include at least two of audio mode, video mode, and text mode.

A method for providing information in a display device according to an exemplary embodiment includes displaying a video content when a predetermined command is input, detecting a plurality of entities included in the video content, and when at least one of the plurality of entities is selected, collecting information regarding the selected at least one entity, and displaying the collected information.

The method may further include obtaining a plurality of tag information regarding each of the plurality of entities, and displaying each of the plurality of tag information adjacent to corresponding entities.

The collecting may include, when at least one of the displayed plurality of tag information is selected, collecting information regarding an entity corresponding to the selected at least one tag information.

The collecting may further include collecting and aggregating information regarding the selected at least one entity from a plurality of information sources, and the displaying the collected information may include displaying the aggregated information.

The information regarding the selected at least one entity may be information in at least one of text form, audio form, and image form.

The displaying the collected information may include providing information regarding the selected at least one entity in at least one of a plurality of presentation modes.

The plurality of presentation modes may include at least two of audio mode, video mode, and text mode.

### BRIEF DESCRIPTION OF THE DRAWINGS

The above and/or other aspects will be more apparent by describing certain exemplary embodiments with reference to the accompanying drawings, in which:

FIG. 1 is a configuration view of a system environment according to various exemplary embodiments;

FIG. 2 is a block diagram of a display device which presents information on entities included in a video content according to an exemplary embodiment;

FIG. 3 is a view illustrating a module included in a display device which presents information on entities included in a video content according to an exemplary embodiment;

FIG. 4 is a flowchart provided to explain a method for presenting information on entities included in a video content according to an exemplary embodiment;

FIG. 5 is a view illustrating that information on entities included in a video content is presented according to an exemplary embodiment; and

FIG. 6 is a flowchart which illustrates a method for providing information on entities included in a video content according to another exemplary embodiment.

### DETAILED DESCRIPTION OF EXEMPLARY EMBODIMENTS

It should be observed the method elements and system components have been represented by related art symbols in the figure, showing only specific details which are relevant for an understanding of the exemplary embodiments. Further details may be readily apparent to persons of ordinarily skill in the art may not have been disclosed. In the exemplary embodiments, relational terms such as first and second, and the like, may be used to distinguish one entity from another entity, without necessarily implying any actual relationship or order between such entities.

Exemplary embodiments described herein provide a system and method of presenting information on entities included in a video content, a live video, a streaming video and a stored video, in accordance with an exemplary embodiment.

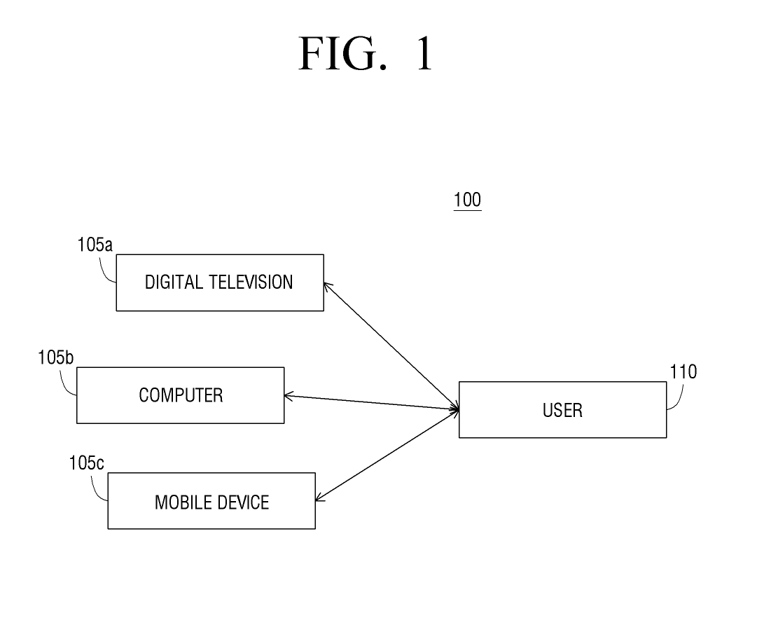

FIG. 1 is a block diagram of an environment 100 in accordance with an exemplary embodiment. The environment 100 includes electronic devices, for example, a digital television (DTV) 105a, a computer 105b and a mobile device 105c. The environment 100 also includes a user 110. The electronic devices may constantly receive and present video content to the user 110. Examples of the video content include, but are not limited to, a live video, a streaming video and a stored video.

The video content includes multiple entities. Examples of the entities include, but are not limited to, individuals, monuments, objects, products, living beings, for example, animals, birds and trees. The multiple entities are displayed while the video content is being played on the electronic devices. The user 110, while watching the video content, may wish to acquire information of one or more entities. Hence, the user 110 activates an information fetching mode on the electronic device. The information fetching mode can be activated using one or more input devices, for example, but not limited to, a remote, keyboard, a television menu and a pointing device.

Upon activating the information fetching mode, one or more entities are tagged automatically. Each entity of the one or more entities is associated with a tag. The tag associated with each entity includes tag information. The tag information includes, but is not limited to, the name of the entity, location information associated with the entity and the like. Further, other details can also be included in the tag. The tag provided for each entity is thus displayed adjacent to the entity for viewing by the user 110. The tag information associated with each entity is stored in a tag information database.

Upon displaying the tag for each entity, the user 110 selects one or more entities. Selection is performed to obtain information associated with each entity that is selected by the user 110. Selection can be performed using one or more input devices, for example, but not limited to, the remote, the television menu, the keyboard and the pointing device. Further, upon selecting the entities, information associated with each of the entities is collected. The information can be collected from various sources. Examples of the sources include, but are not limited to, a cloud network and a local storage device. Multiple servers located locally or remotely, present in the cloud network can be used for collecting information associated with each of the entities selected. Further, the information collected from the sources is aggregated using pre defined rules. Furthermore, the aggregated information associated with each of the entities is thus presented to the user.

Multiple presentation modes can be used for presenting the aggregated information. The presentation modes are selected by the user 110. Examples of the presentation modes include, but not limited to, an audio mode, a video mode and a textual mode. The aggregated information is presented to the user 110 based on the presentation mode selected by the user 110.

In one example, the user 110 may be watching a cricket match broadcasted in real time on the DTV 105a. The user 110 may wish to obtain information on, but not limited to, a player's details, playground information and individuals umpiring the cricket match. Hence, the user activates the information fetching mode on the DTV. As a result of activating the information fetching mode, the player, the playground and the individuals umpiring the cricket match can be automatically tagged. In such a case, the user 110 selects the player, the playground and the individuals umpiring the cricket match to obtain the information. Further, the information associated with the player, the playground and the individuals umpiring the cricket match is collected from multiple sources. The information collected from the multiple sources is further aggregated. The aggregated information is subsequently presented to the user 110 in various presentation modes.

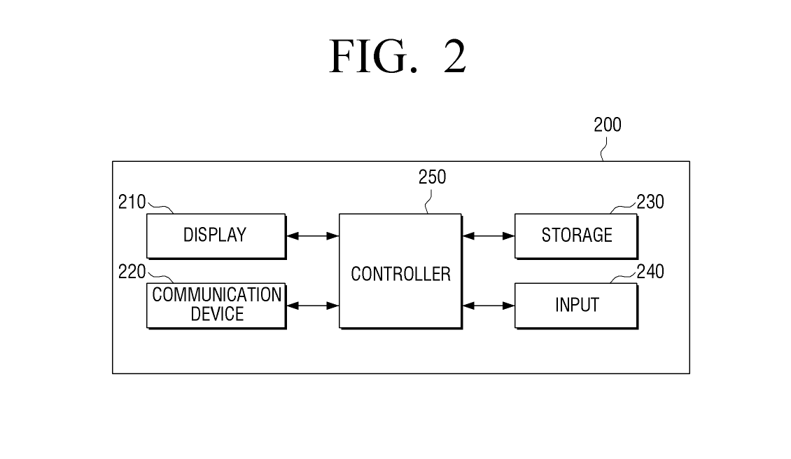

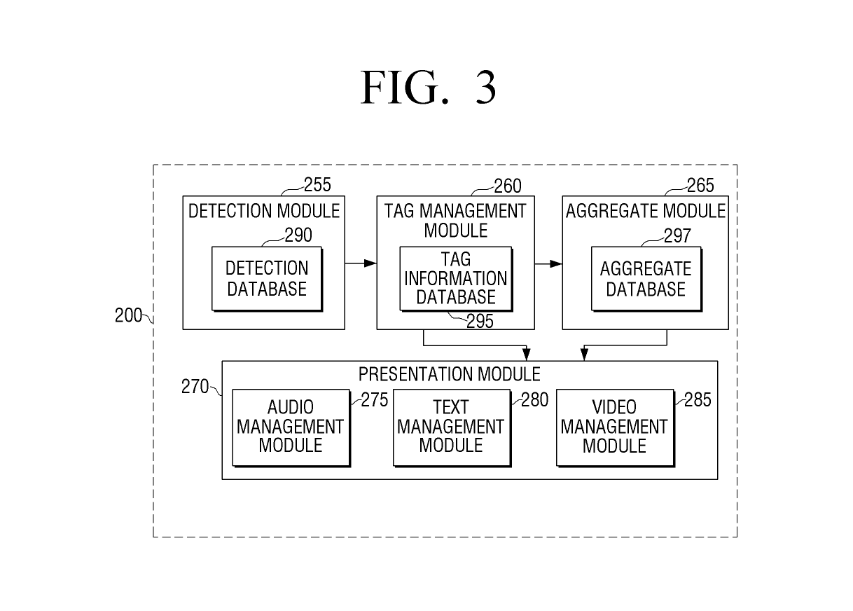

A display device which displays information on one or more entities or an image included in a video content will be described in detail with reference to FIGS. 2 and 3.

FIG. 2 is a block diagram of a display device 200 which presents information on entities included in a video content according to an exemplary embodiment. As illustrated in FIG. 2, the display device 200 comprises a display 210, a communication device 220, a storage 230, an input 240, and a controller 250. In this case, the display device 200 may be realized as one of a digital television, a computer, and a mobile device, but is not limited thereto.

The display 210 outputs image data under the control of the controller 250. In particular, the display 210 displays a video content which is input. In this case, the video content may include one or more entities. In the information fetching mode, the display 210 may display tag information of one or more entities adjacent to the corresponding entities. In addition, the display 210 may display information on entities selected by a user.

The communication device 220 performs communication with an external device. In particular, the communication device 220 may receive information on entities selected by a user through an external device or a server.

The storage 230 stores various data and programs which are necessary to drive the display device 200. In particular, the storage 230 may comprise a sensing or detection database 290 for storing detected entities, a tag information database 295 for storing and maintaining tags of each entities, and aggregate database 297 for storing aggregated information related to each entities.

The input 240 receives a user command to control the display device 200. In particular, the input 240 may receive a user command to enter into the information fetching mode and a user command to select one of a plurality of entities.

The input 240 according to an exemplary embodiment may be realized as an input device such as a remote controller, a touch screen, a television menu, a pointing device, etc., but is not limited thereto.

The controller 250 controls overall operations of the display device 200 according to a user command input through the input 240. In particular, the controller 250 may control a module included in the display device 200.

To be specific, if a predetermined command is input through the input 240, the controller 250 detects a plurality of entities included in video content. Subsequently, when one or more entities of the detected plurality of entities are selected through the input 240, the controller 250 controls the display 210 to collect information on the selected one or more entities through the communication device 220 and display the collected information.

To be specific, if a user command to enter into the information fetching mode is input, the controller 250 detects a plurality of entities included in a video content displayed on the display 210.

When the plurality of entities are detected, the controller 250 obtains a plurality of tag information regarding each of the plurality of entities. In addition, the controller 250 may control the display 210 to display each of the plurality of tag information adjacent to the corresponding entities. If at least one tag information from among the displayed plurality of tag information is selected through the input 240, the controller 250 may collect information on the entitles corresponding to the selected at least one tag information may be collected through the communication device 220.

In particular, the controller 250 may collect and aggregate information related to the selected at least one entity from a plurality of information sources. In this case, the information collected from a plurality of information sources may be in at least one of text form, audio form, and image form.

In addition, the controller 250 may control the display 210 to display the aggregated information. In this case, the controller 250 may provide information related to the selected at least one entity to at least one of a plurality of presentation modes. For example, the controller 250 may provide the aggregated information to at least one of an audio mode, a video mode, and a text mode. In this case, the controller 250 may process the collected information according to the presentation mode. For example, if the information is provided to the audio mode and the collected information is in the text form, the controller 250 may process the information in the text form to be in the audio form.

As described above, the display device 200 allows a user to check information regarding a plurality of entities displayed on the display device 200 intuitively and conveniently.

FIG. 3 is a view illustrating a module included in the display device 200 which presents information on entities displayed on a video content according to an exemplary embodiment. The display device 200 comprises a detection module 255, a tag management module 260, an aggregate module 265, and a presentation module 270. The above-described components of the display device 200 are connected to each other through communication interfaces.

The detection module 255 is used to detect at least one entity in a video content. The examples of such a video content include live video, streaming video, and stored video, but are not limited thereto. In another example, at least one entity may exist in an image or a digital graphic content. A video content is reproduced in the display device 200. The examples of the display device 200 include a DTV, a mobile device, a computer, a notebook computer a PDA, and a portable devices, but are not limited thereto. The examples of the entities include figures, monuments, object, products, animals, birds, trees, etc., but are not limited thereto. For example, the entities may be something that is known publicly. The detection module 255 uses various detection algorithms to detect entities in a video content or in a recorded video. For example, a face detection algorithm is used to recognize a face of a person included in a video content. In another example, image processing algorithms are used to recognize various entities included in a video content. The detection module 255 may detect entities in real time.

The detection module 255 may further comprise database such as detection database 290 to store detected entities.

The tag management module 260 provides a tag for each of the detected entities automatically. The tag management module 260 provides a tag of each entity automatically since the entities are known publicly. The tag, for example, may include the name and location of the detected entities. According to an exemplary embodiment, the tag management module 260 provides a tag in real time as entities are searched. The tag management module 260 obtains a tag of entities from at least one information source. The examples of such an information source include a local database, a remote storage device, and the Internet, but are not limited thereto. The tag management module 260 further comprise a tag information database 295 to store and retain a tag of each entity.

The aggregate module 265 may aggregate information related to each entity detected by the detection module 255. Prior to performing the aggregation, the aggregate module 265 collects information related to each entity from information sources. In addition, the aggregate module 265 comprises a database such as the aggregate database 297 to store aggregated information related to each entity.

For example, if a renowned individual appears in a video content, that individual is automatically tagged since he is a renowned figure. In addition, the user 110 may wish to obtain information related to the individual while watching the video content. Accordingly, the user 110 may select the renowned individual. In this case, information related to the individual is collected from information sources. For example, the information related to the individual may include the full name, birth year and date, occupation, and other information involving the individual.

The presentation module 270 may be configured to display aggregated information related to each entity. In addition, the presentation module 270 may be configured to display aggregated information in various presentation modes. The examples of the presentation modes include audio mode, video mode, text mode, etc., but are not limited thereto.

The presentation module 270 further comprises an audio management module 275 for displaying information in the audio form, a text management module 280 for displaying information in the text form, and a video management module 285 for displaying information in the video form. The user 110 may select an audio form, a text form, a video form, or a form which combines the three forms in order to obtain information displayed by the presentation module 270.

The audio management module 275 obtains information regarding each entity from the aggregate database 297. One or more communication interfaces may be used to obtain information regarding entities in the audio form.

In addition, a karaoke option may be set such that information included in the text form can be displayed. The text management module 280 supports such a karaoke option.

The audio management module 275 processes information regarding entities. In an exemplary embodiment, the information regarding entities may be in the text form. The audio management module 275 processes information which is displayed in the text form to an audio signal. In this case, the process may include audio-text conversion.

According to an exemplary embodiment, when an audio mode is selected, a user may select a language. When a language is selected, the audio management module 275 reproduces information regarding entities in the audio form. The audio form includes information. In addition, the information in the audio form may be reproduced in at least one language that a user prefers. In an exemplary embodiment, a multi-language mode may be selected in order to reproduce information in the audio form in at least one in at least one language that a user prefers. In an exemplary embodiment, at least one web link of various audio clips related to entities may be provided to a user. One or more natural language processing (NLP) algorithms may be used to provide information regarding a language selected by a user.

The text management module 280 obtains information regarding each entity from the aggregate database 297, and a communication interface may be used to obtain such information. In addition, the text management module 280 processes information related to entities. Such processing includes processing information related to entities to be in the text form. When the conversion is performed, the text management module 280 displays information related to entities in the text form. In an exemplary embodiment, texts may be displayed in the form of a booklet and so on. In addition, the text management module 280 may briefly display important explanation regarding entities in the text form.

In an exemplary embodiment, the text management module 280 may display a corresponding text in one or more languages that a user prefers.

The video management module 285 obtains information regarding each entity from the aggregate database 297, and the communication interface may be used to obtain such information. In addition, the video management module 285 processes information regarding entities, which includes converting the information regarding entities into a video form. When performing such conversion, the video management module 285 displays the information regarding entities in a video form. In an exemplary embodiment, the video management module 285 may operate to provide a user with at least one link of various video clips related to entities. In addition, the video management module 285 may allow users to select one link simultaneously. When making a selection, the video management module 285 may operate to reproduce a video clip selected by a user using a picture in picture (PIP) technology, and so on.

According to an exemplary embodiment, the display device 200 may operate to store a plurality of entities which are selected by a user and tagged automatically in order to provide information regarding the plurality of entities. In addition, the display device 200 may operate to store each of a plurality of entities selected by a user in a database. Further, the display device 200 may operate to provide a serial number to each of the plurality of entities. The display device 100 may operate to collect information regarding each entity, and display corresponding information to a user in a different presentation mode according to the user's selection.

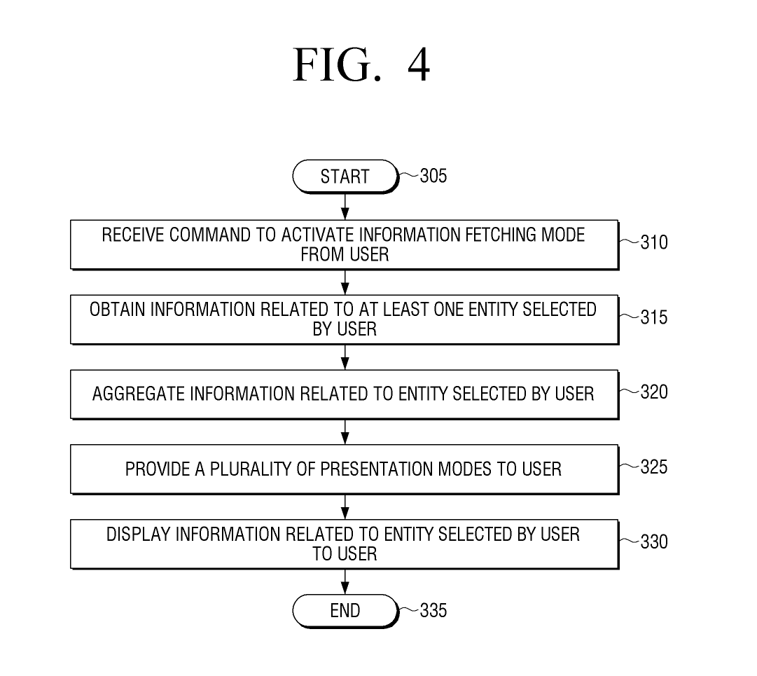

FIG. 4 is a flowchart illustrating a method of presenting information for entities displayed on a video content, in accordance with an exemplary embodiment.

The method starts at operation 305. At operation 310 an input is received from a user, for example, the user 110. The input can include the user activating an information fetching mode while watching a video content. Examples of the video content include, but are not limited to, a live video, a streaming video and a stored video. The live stream includes a video content that is broadcasted directly. The streaming video includes multiple video contents from, for example, but not limited to, a cloud server. Examples of the streaming video include, but are not limited to, Youtube videos and the like. The stored stream may include a video content or an audio content that is played from a local storage device, for example, a compact disk, a hard disk and the like. Activation of the information fetching mode enables the user to acquire information associated with multiple entities included in the video content. Upon activating the information fetching mode, the entities are detected automatically in real time. A detection module, for example the detection module 205 can be used to detect the entities. Further, the entities detected are automatically tagged since the information fetching mode is activated by the user. In one example, famous entities included in the video content are automatically tagged in response to the user activating the information fetching mode. Each of the entities that are tagged is associated with a tag information. The tag information, in one example can include the name of the entity, a location associated with the entity, or a brief description of the entity. The detected entities are tagged automatically by a tag managing module, for example the tag managing module 210. Further, a tag information associated with each entity is stored in a tag information database, for example, the tag information database 245.

According to an exemplary embodiment, the input also includes one or more entities, of the multiple entities present in the video content, selected by the user. The one or more entities are selected for obtaining information associated with each of the entities selected by the user. The user can select the entities using one or more input devices. Examples of the input devices include, but are not limited to, a remote controller, a television menu, pointing devices and the like. Upon being selecting, the one or more entities are highlighted.

At operation 315, the information associated with the entities, selected by the user, are obtained. The information is obtained from multiple information sources. Examples of the information sources include, but are not limited to, a local storage device, a remote storage device and the Internet. The information can be obtained in a textual format or an image format. Further, one or more links to audio clips associated with the selected entity and one or more links to video clips associated with the selected entity are also obtained in the textual format.

At operation 320, the information of the entities, selected by the user, that are obtained from the multiple information sources, are aggregated. Various aggregation algorithms can be used to perform aggregation. One or more pre-defined rules can be used to perform the aggregation. An aggregator module, for example, the aggregator module 320 is used to obtain and aggregate the information associated with the entities selected by the user.

At operation 325, multiple presentation modes are provided to the user. Examples of the presentation modes include, but are not limited to, an audio mode, a video mode and a textual mode. The presentation modes are used to present the information associated with entities selected by the user in various data formats. Examples of the data formats include, but are not limited to, an audio format, a video format and a textual format. The user can select a single presentation mode or a combination of presentation modes. The input devices can be used for selecting the presentation modes.

In one example, if the user selects a textual mode, then the information, associated with the entities is presented to the user in a textual format. Simultaneously, the user can also select the audio mode. Upon selecting the audio mode, the information presented in the textual format is converted into the audio format.

At operation 330, the information associated with the entities, selected by the user, are presented to the user. The information is presented to the user based on the presentation mode selected by the user. In one example, if the audio mode is selected by the user, then information, such as, but not limited to, one or more audio clippings associated with a selected entity is collected from the information sources. The information collected from the information sources is aggregated. Further, aggregated information, associated with the selected entity, is converted in the form of an audio. Subsequently, the audio is played, to the user, using one or more audio output devices, for example, a head phone, an external speaker and the like. An audio managing module, for example, the audio managing module 225 is used to convert and present the information, to the user, in the form of the audio.

According to some exemplary embodiments, upon selecting the audio mode, the user can also select a language. Upon selecting the language, the aggregated information can be played in the language selected by the user. In some exemplary embodiments, one or more web links of various audio clips associated with the entity can also be provided to the user. One or more natural language processing (NLP) algorithms can be used for presenting the information in any language selected by the user. One or more audio output devices included in the display device may be used for playing the information in the audio format.

Further, a karaoke option can also be enabled for presenting the aggregated information that is included in the form of text. A text managing module, for example, the text managing module 230 supports the karaoke option.

In another example, if the video mode is selected by the user, then information, such as, but not limited to, one or more video clippings associated with the selected entity is collected from the information sources. The information collected from the information sources is aggregated. Further, aggregated information, associated with the selected entity, is converted in the form of a video. Subsequently, the video is played, to the user, using one or more media players. In some exemplary embodiments, one or more web links of various video clips associated with the entity can also be provided to the user. The user can instantly select one link. Further, upon being selected the selected video clip is played using, for example, a picture in picture (PIP) technology. A video managing module, for example, the video managing module 235 is used to convert and present the information, to the user, in the form of the video.

In another example, if the textual mode is selected, by the user, then information associated with the selected entity is collected from the information sources. The information collected from the information sources is aggregated. Further, aggregated information, associated with the selected entity, is presented, to the user, in the form of text. In one example, the text can be presented in the form of pamphlets and the like. Further, the presents a significant description of the entity briefly in the text format.

According to some exemplary embodiments, the text managing module 230 can present the text in one or more languages as desired by the user. A text managing module, for example, the text managing module 230 may be used to present the information associated with the selected entity in the form of text.

According to some exemplary embodiments, the user may select multiple entities that are tagged for obtaining the information associated with the multiple entities. Each of the multiple entities selected by the user is stored in a queue in a database. In such a case, each of the multiple entities is provided with a sequence number. Subsequently, based on the sequence number, the information associated with each entity is obtained from the queue and further presented, to the user, in different presentation modes as selected by the user.

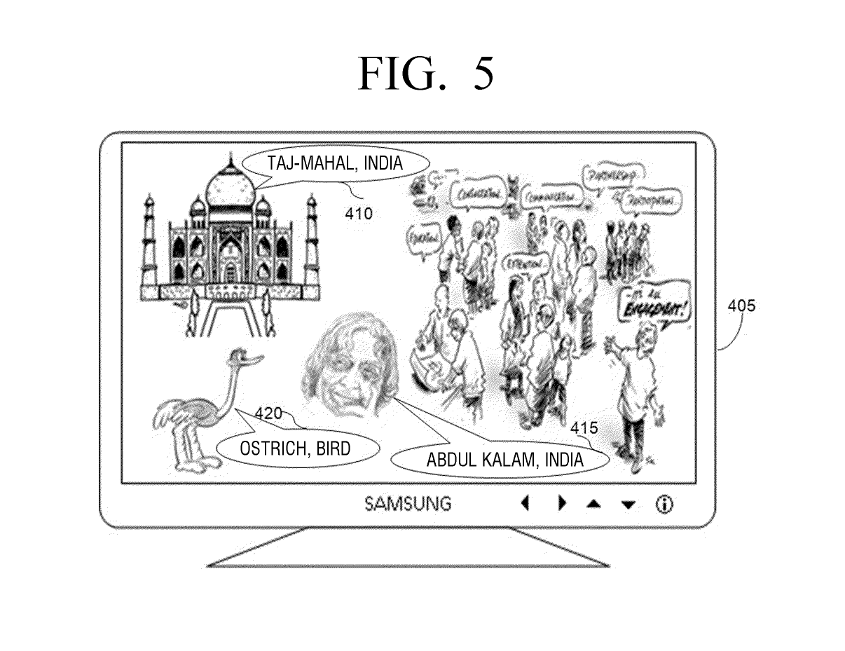

According to an exemplary embodiment as illustrated in FIG. 5, information for entities is displayed on a video content. FIG. 5 includes, in one example, a DTV 405. A recorded video stream is played by the DTV 405.

A user, for example, the user 110 activates an information fetching mode while watching the video content played by the DTV 405. Input devices for example, but not limited to, a remote controller, a DTV menu and a pointing device can be used for activating the information fetching mode. Upon activating the information fetching mode, one or more entities are highlighted and further tags are automatically displayed for the entities included in the video content. Hence, a tag 410 named ‘Taj Mahal’ is displayed adjacent to entity Taj Mahal on the DTV 405. Further, a tag 415 named ‘Abdul Kalam’ is displayed adjacent to entity “Abdul Kalam” on the DTV 405. Furthermore, a tag 420 named ‘Ostrich’ is displayed adjacent to entity Ostrich on the DTV 405.

In one example, the user can select the entity “Abdul Kalam” using one or more input devices. Examples of the input devices include, but are not limited to, a remote controller, a television menu, pointing devices and the like. Selecting the entity “Abdul Kalam” enables the user to acquire information associated with the entity “Abdul Kalam” included in the video content. Information, for example, but not limited to, the date and place of birth of “Abdul Kalam”, the profession associated with “Abdul Kalam”, past professional details associated with “Abdul Kalam” and current designation of “Abdul Kalam” can be presented.

Further, the user can also select one or more presentation modes for acquiring the information. Examples of the presentation modes include, but not limited to, an audio mode, a video mode and a textual mode. In one example, if the user selects the audio mode, then the information associated with “Abdul Kalam” is presented, to the user, in the form of an audio that can be played using one or more audio output devices for example, a head phone, an external speaker and the like associated with the display device. In another example, if the user selects the video mode, then the information associated with “Abdul Kalam” is presented, to the user, in the form of a video that can be played using the media players. In some exemplary embodiments, one or more web links of various video clips associated with the entity can also be provided to the user. The user can select one link at one instant. Further, upon being selected, the selected video clip is played using, for example, a picture in picture (PIP) technology. In yet another example, if the user selects the textual mode, then the information associated with “Abdul Kalam” is presented, to the user, in the form of a text, for example, but not limited to, in a pamphlet form. In one example, significant information, for example, the first name, the full name, the birth date, the birth place, education, profession and the like, associated with “Abdul Kalam” can be displayed similar to a selected form. Similarly, the user can select other entities displayed on the DTV 405 for obtaining information associated with the other entities.

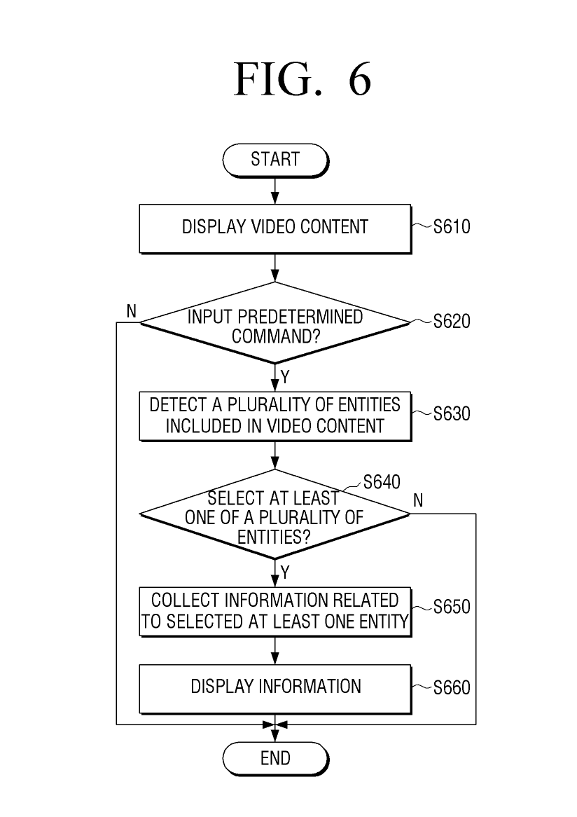

Hereinafter, the method that the display device 200 provides information regarding entities included in a video content will be explained with reference to FIG. 6.

First of all, the display device 200 displays a video content (operation S610). In this case, the video content may include one or more entities.

Subsequently, the display device 200 determines whether a predetermined command is input. In this case, the predetermined command may be a command to select a predetermined button of a remote controller which is interlocked with the display device 200, or a command to select a predetermined icon of a menu displayed on the display device 200.

When a predetermined command is input (operation 5620-Y), the display device 200 detects a plurality of entities included in a video content (operation S630). In this case, the display device 200 may obtain information regarding a plurality of tags corresponding to each of a plurality of entities and display each of the plurality of tag information adjacent to each of the corresponding entities.

Subsequently, the display device 200 determines whether at least one of the plurality of entities is selected (operation S640).

When at least one of the plurality of entities is selected (operation S640-Y), the display device collects information regarding the selected at least one entity (operation S650). In particular, when at least one of the displayed plurality of tag information is selected, the display device 200 may collect information regarding entities corresponding to the selected at least one tag information. In this case, the display device 200 may collect and aggregate information related to the selected at least one entity from a plurality of information sources.

The display device 200 displays the collected information (operation S660). In particular, when the information collected from a plurality of information sources is aggregated, the display device 200 may display the aggregated information. Meanwhile, in the exemplary embodiment, the display device 200 displays the collected information, but this is only exemplary. The display device 200 may provide the collected information in the audio form or in the text form.

The exemplary embodiments obtain information associated with one or more entities while a user is watching video content. By presenting the information, the user can gain knowledge associated with one or more entities while watching the video content. Further, an audio mode allows the user to obtain information associated with an entity while viewing the video simultaneously without getting disturbed. For example, exemplary embodiments further enable one or more education institutions to educate the users, parliaments to know current political situations, and sports enthusiasts to obtain information related to a currently viewed sporting event. These examples are only exemplary, since the exemplary embodiments may be used in various other fields.

The foregoing exemplary embodiments are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A display device, comprising:
a display configured to display a video content;
a communication device configured to communicate with an external device;
an input configured to receive a user command; and
a controller configured to, when a predetermined command is input through the input, detect a plurality of entities included in the video content, and when at least one of the plurality of entities is selected through the input, control the display to collect and display information regarding the selected at least one entity through the communication device.

2. The display device as claimed in claim 1, wherein the controller obtains a plurality of tag information regarding each of the plurality of entities, and
wherein the display displays each of the plurality of tag information adjacent to each entity.

3. The display device as claimed in claim 2, wherein the controller, when at least one of the displayed plurality of tag information is selected through the input, collects information regarding an entity corresponding to the selected at least one tag information through the communication device.

4. The display device as claimed in claim 1, wherein the controller collects and aggregates information regarding the selected at least one entity from a plurality of information sources, and
wherein the display displays the aggregated information.

5. The display device as claimed in claim 1, wherein the information regarding the selected at least one entity is information in at least one of a text form, an audio form and an image form.

6. The display device as claimed in claim 1, wherein the controller provides information regarding the selected at least one entity in one of a plurality of presentation modes.

7. The display device as claimed in claim 6, wherein the plurality of presentation modes include at least two of an audio mode, a video mode, and a text mode.

8. A method for providing information in a display device, the method comprising:
displaying a video content;
when a predetermined command is input, detecting a plurality of entities included in the video content;
when at least one of the plurality of entities is selected, collecting information regarding the selected at least one entity; and
displaying the collected information.

9. The method as claimed in claim 8, further comprising:
obtaining a plurality of tag information regarding each of the plurality of entities; and
displaying each of the plurality of tag information adjacent to corresponding entities.

10. The method as claimed in claim 9, wherein the collecting comprises, when at least one of the displayed plurality of tag information is selected, collecting information regarding an entity corresponding to the selected at least one tag information.

11. The method as claimed in claim 8, wherein the collecting further comprises:
collecting and aggregating information regarding the selected at least one entity from a plurality of information sources, and
wherein the displaying the collected information comprises displaying the aggregated information.

12. The method as claimed in claim 8, wherein the information regarding the selected at least one entity is information in at least one of a text form, an audio form, and an image form.

13. The method as claimed in claim 8, wherein the displaying the collected information comprises providing information regarding the selected at least one entity in at least one of a plurality of presentation modes.

14. The method as claimed in claim 13, wherein the plurality of presentation modes include at least two of an audio mode, a video mode, and a text mode.

15. A method for providing information in a display apparatus, the method comprising:
displaying video content;
detecting a plurality of entities in the video content;
obtaining tag information regarding the plurality of entities in the video content;
displaying the tag information adjacent to corresponding entities; and
when at least one of the displayed tag information is selected, collecting information regarding an entity corresponding to the selected at least one tag information.

16. The method of claim 15, wherein the collecting comprises collecting and aggregating information regarding the corresponding entity from a plurality of information sources.

17. The method of claim 15, wherein the information regarding the corresponding entity comprises information in at least one of text form, audio form, and image form.
